(19) United States
(12) Patent Application Publication
(10) Pub. No.: US 2026/0044339 A1
(43) Pub. Date: Feb. 12, 2026

(54) NON-BLOCKING VECTOR INSTRUCTION DISPATCH WITH MICRO-OPERATIONS

(71) Applicant: Akeana, Inc., Santa Clara, CA (US)

(72) Inventors: Hai Ngoc Nguyen, Redwood City, CA (US); Abhijit Sil, Dublin, CA (US)

(73) Assignee: Akeana, Inc., Santa Clara, CA (US)

(21) Appl. No.: 19/290,518

(22) Filed: Aug. 5, 2025

Related U.S. Application Data
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.

(51) Int. Cl. G06F 9/30; G06F 9/345; G06F 9/38; G06F 12/0897

(52) U.S. Cl. CPC G06F 9/30036; G06F 9/30043; G06F 9/3455; G06F 9/3814; G06F 12/0897

(57) ABSTRACT

A processor core is coupled to a memory hierarchy. The processor core is configured to execute vector instructions, scalar instructions, and micro-operations. A dispatch unit within the processor core receives a vector memory operation. The dispatch unit sends the vector memory operation to a first vector input queue of multiple vector input queues. The sending is based on the memory addressing mode. A micro-operation sequencer splits the vector memory operation into one or more memory micro-operations, which includes forwarding each micro-operation within the one or more micro-operations to a first memory queue within multiple memory queues. A memory operation is then issued to a load-store unit within the processor core. The issuing includes selecting, from the multiple memory queues, the memory operation. The vector memory operation comprises either a vector load operation or a vector store operation.

### RELATED APPLICATIONS

This application claims the benefit of U.S. provisional patent applications “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702, 192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

Each of the foregoing applications is hereby incorporated by reference in its entirety.

### FIELD OF ART

This application relates generally to computer processors and more particularly to non-blocking vector instruction dispatch with micro-operations.

### BACKGROUND

Processor efficiency is vital for the performance and functionality of modern products across various industries. Efficient processors lead to faster, more responsive systems, which are crucial for applications requiring quick response times, like gaming, real-time processing, and high-performance computing. Efficient processors also consume less power, extending battery life in portable devices and lowering energy costs in data centers, which is key for promoting sustainability and mitigating environmental impact. Additionally, efficient processors generate less heat, which is important for thermal management in devices such as laptops, servers, and embedded systems, and serve to prevent overheating and maintaining stable operation. This efficiency allows for sleek, compact designs, especially important for mobile devices, wearables, and IoT devices where size and weight matter. Overall, efficient processors save costs in manufacturing and operations, reduce electricity expenses, and enable smaller cooling solutions, leading to further savings.

Main categories of processors include Complex Instruction Set Computer (CISC) types, and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool which in turn creates the gate-level abstraction of the design that is used for downstream implementation operations.

Processor efficiency is crucial for performance, power use, and user experience in modern products. As technology advances, there is an increasing focus on creating processors that balance high performance with energy efficiency to cater to the diverse needs of different applications and industries.

### SUMMARY

The performance of processors in a device directly affects its overall utility. Common applications include mobile devices, wearables, consumer electronics, automotive systems, edge computing, and IoT. In processors like RISC processors, efficient instruction pipelines are essential for performance. These pipelines can handle vector operations, which can be broken into micro-operations for execution. Efficient pipelines can allow multiple micro-operations to run concurrently, increasing instruction throughput. By dividing execution into stages, each stage can be optimized for specific tasks, speeding up processing.

Disclosed techniques enable vector instruction processing. A processor core is coupled to a memory hierarchy, and the processor core is configured to execute vector instructions, scalar instructions, and micro-operations. A dispatch unit within the processor core receives a vector memory operation. The dispatch unit sends the vector memory operation to a first vector input queue of multiple vector input queues, based on the memory addressing mode. A micro-operation sequencer splits the vector memory operation into one or more memory micro-operations, which includes forwarding each micro-operation within the one or more micro-operations to a first memory queue within multiple memory queues. A memory operation is then issued to a load-store unit within the processor core, where the issuing includes selecting, from the multiple memory queues, the memory operation.

Disclosed embodiments provide a processor-implemented method for vector processing comprising: accessing a processor core, wherein the processor core is coupled to a memory hierarchy, and wherein the processor core is configured to execute vector instructions, scalar instructions, and micro-operations; receiving, by a dispatch unit within the processor core, a vector memory operation, wherein the vector memory operation is associated with a memory addressing mode, wherein the receiving includes deciding to divide the vector memory operation into one or more micro-operations; sending, by the dispatch unit, the vector memory operation to a first vector input queue within a plurality of vector input queues, wherein the sending is based on the memory addressing mode; splitting, by a micro-operation sequencer within the first vector input queue, the vector memory operation into one or more memory micro-operations, wherein the splitting includes forwarding each micro-operation within the one or more micro-operations to a first memory queue within a plurality of memory queues; and issuing, to a load-store unit within the processor core, a memory operation, wherein the issuing includes selecting, from the plurality of memory queues, the memory operation. In embodiments, the memory addressing mode comprises a constant stride addressing mode. In embodiments, the memory addressing mode comprises an indexed stride addressing mode. In embodiments, the vector memory operation comprises a vector load operation. In embodiments, the vector memory operation comprises a vector store instruction.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for non-blocking vector instruction dispatch with micro-operations.

FIG. 2 is a flow diagram for selecting from memory queues.

FIG. 3 is a block diagram of a multicore processor.

FIG. 4 is a block diagram of a pipeline.

FIG. 5 is a block diagram for dispatching instructions.

FIG. 6 is an example of dispatching vector and scalar instructions.

FIG. 7 is a system diagram for non-blocking vector instruction dispatch with micro-operations.

### DETAILED DESCRIPTION

Techniques for non-blocking vector instruction dispatch with micro-operations are disclosed. A processor instruction pipeline can include at least a fetch stage, an align/decode stage, and a dispatch stage, among other stages. The dispatch stage can maintain a reorder buffer (ROB) that indicates an arrival order in the dispatch stage. An execution stage can follow the dispatch stage. The ROB is used to ensure proper sequencing and retiring of instructions. The retiring can include successfully completing the execution, and writing of results of the instruction back to the register file and/or memory. The dispatch unit can maintain a reorder buffer identifier (ROBID) that is used to ensure that instructions are completed in the correct program order, while still supporting an out-of-order instruction architecture.

Use of a pipeline, or “pipelining,” reduces the time it takes to execute a series of micro-operations by providing the micro-operations to the pipeline. This technique enables the processor to initiate processing of a next operation before the previous operation has completed. Shortening the execution time of individual operations translates to faster overall program execution. The increased processor performance attributable to sequencing of the micro-operations can occur when an operation exploits instruction-level parallelism (ILP). The ILP enables multiple instructions or operations to be in various stages of execution simultaneously. Furthermore, efficient pipelines help maintain a steady flow of operations through the processor, reducing the likelihood of operation stalls or bottlenecks. A seamless operation flow ensures that the processor can consistently perform at or near its peak capabilities.

Instruction sets can include scalar instructions and vector instructions. Scalar instructions may operate on individual data points, and may use general-purpose registers for data storage. Scalar instructions are often used in branching and control instructions. Vector instructions/operations can operate on multiple data elements simultaneously. Vector instructions may utilize dedicated vector registers, allowing for operations on entire arrays. Vector instructions can serve to increase throughput by performing the same operation across data sets with fewer instructions.

Extensions such as vector operation extensions can be enabled for a processor architecture such as a RISC-V processor core. Vector operations can, with a single instruction, require many individual operations to complete the single instruction. For example, vector operations such as scalar multiplication, vector addition, vector dot product, vector cross product, and so on can involve several steps and complex operations to accurately compute the result of the vector operation. One step can include operand preparation. This step can include the alignment of one or more vectors. In one or more exemplary implementations, the actual vector operation can be performed using hardware components including, but not limited to, pipelines dedicated to vector operations. In some exemplary implementations, an iterative or algorithmic approach may be used to execute the vector operation. Vector registers in a processor are designed to efficiently handle operations on multiple data elements simultaneously. These registers enable a single instruction to operate on multiple data elements, which is particularly beneficial for tasks that involve large datasets and parallel processing. The vector registers can support addition and/or subtraction of corresponding elements of two vectors, producing a new vector as the result. Additionally, other operations, including, but not limited to, vector multiplication, vector division, vector dot product, vector shifts, and/or other operations, can be supported with vector registers. Furthermore, the vector operations can include vector load and store operations to enable loading data from memory into the register or storing data from the register back to memory. A vector operation can be executed by splitting a vector operation into a series of micro-operations and initiating execution of the series of micro-operations. The vector operation can be queued in a vector memory instruction input queue. The vector memory instruction input queue can be coupled to a micro-operation sequencer. The micro-operation sequencer can generate a series of micro-operations based on an input vector memory instruction. Concurrently, scalar memory operations can be routed to respective scalar load queues and/or scalar store queues.

While the pipelining in RISC architectures can improve performance, a mix of scalar and vector instructions (including vector instructions that have been divided into multiple vector micro-operations) can create stalls in a processor pipeline. Pipeline stalls lead to a reduction in the overall instruction throughput, slowing down program execution. Each stalled cycle adds latency, delaying the completion of instructions. Moreover, pipeline stages are left idle during stalls, leading to inefficient use of CPU resources. In particular, since a vector instruction can take longer to process than a scalar instruction, processing of a vector instruction in the dispatch stage could potentially create a situation where scalar instructions are waiting to enter the pipeline, causing a bottleneck. Disclosed techniques address the aforementioned issues of bottlenecks caused by vector instructions by providing additional queues for storing vector instructions, and processing vector instructions created by a micro-operation sequencer. A reorder buffer identification (ROBID) parameter is used to ensure that instructions do not age within a queue prior to dispatch and that all instructions are retired in order, while still supporting out-of-order (OoO) execution.

Because they operate on multiple data elements, vector instructions can be complex. One of the ways to deal with that complexity is to split a vector operation into multiple instructions via a micro-sequencer. However, because multiple instructions now replace a single instruction in the processor pipeline, stalls can occur. For example, a vector operation can be fetched, decoded, and assigned a ROBID by the dispatch unit. A micro-sequencer can split the instructions within the dispatch unit. In that case, all of the micro-operations can be assigned the same ROBID in order to preserve the correct architectural state during writeback. However, the dispatch unit must now handle multiple vector instructions in addition to any scalar instructions that were fetched and decided. This situation can create a delay in dispatching the scalar instruction which may have a ROBID later than the vector micro-instructions. This can result in a scalar pipeline stall and reduced overall performance. Disclosed techniques enable concurrent processing of vector instructions and scalar instructions to reduce the probability of a pipeline stall and improve overall processor performance. In disclosed techniques, the dispatch unit can assign a ROBID and immediately route vector instructions to a vector input queue. The vector input queue can include a vector load input queue (VLIQ) and/or a vector store input queue (VSIQ). The VLIQ and the VSIQ can include a micro-operation sequencer to divide complex vector instructions into multiple less complicated instructions. Thus, the dispatch unit is not taxed with managing as many instructions and instruction flows to the vector pipeline. Similarly, scalar instructions, once assigned a ROBID, can be routed to their respective request queues, such as a scalar load request queue (LRQ), and/or a scalar store request queue (SRQ). A multiplexor (mux) is configured to receive scalar and vector instructions for a given type (load or store). The ROBID is used for mux control to feed the proper instruction to a downstream pipeline stage. Thus, complexity can be removed from the dispatch unit and instructions can be sent immediately to their respective pipelines unimpeded. In this way, the disclosed processor-implemented techniques can provide improvements in the pipelined processing of a mix of scalar and vector instructions, thereby improving overall processer performance for a variety of vector-intensive applications.

Vector-intensive applications can include scientific computing applications such as simulations and numerical analysis that involve matrix operations. The vector-intensive applications can include graphics processing applications that perform tasks such as rendering images and animations, where operations on pixels or vertices are common. The vector-intensive applications can include signal processing applications, such as audio and video processing, where filtering and transformations are frequent. Accordingly, disclosed techniques support these and other vector-intensive applications by enabling concurrent processing of scalar instructions and vector instructions, while reducing the probability of pipeline stalls.

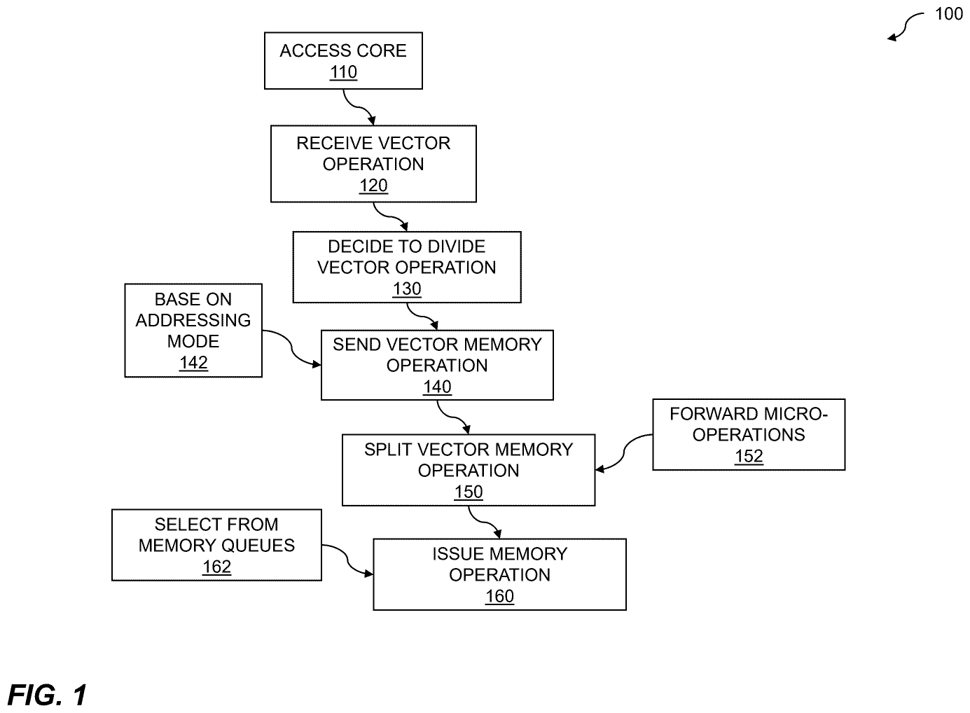

FIG. 1 is a flow diagram for non-blocking vector instruction dispatch with micro-operations. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, and so on. In embodiments, the processor core is coupled to a memory hierarchy. The memory hierarchy can include L1, L2, L3, etc. caches. In embodiments, the memory hierarchy comprises an L1 cache, an L2 cache, and an L3 cache. The memory hierarchy can include memory such as DRAM, SDRAM, and so on. The memory hierarchy can be coherent or non-coherent. In embodiments, the processor core is configured to execute vector instructions, scalar instructions, and micro-operations. The micro-operations can comprise a series of less complex instructions that can take the place of a single, more complex instruction. The micro-operation sequencer can be used for vector instructions, scalar instructions, floating point instructions, and so on. Vector instructions can be executed by the processor within a dedicated vector pipeline while scalar instructions can be executed by a scalar pipeline. The processor can include other instruction pipelines, such as a floating point pipeline.

The flow 100 includes receiving, by a dispatch unit within the processor core, a vector memory operation 120. The vector instruction can include an instruction for data movement, such as load and/or store operations for transferring data between memory and vector registers. The vector sizes supported by the instructions can vary, and can include 64-bit sizes, 128-bit sizes, 256-bit sizes, 512-bit sizes, and/or other suitable sizes. When in the dispatch unit, the vector operation can be assigned a reorder buffer ID (ROBID). The ROBID can be used to ensure that instructions are retired in order while enabling them to execute within the process in an out-of-order fashion. In embodiments, the vector memory operation is associated with a memory addressing mode. The memory addressing mode can comprise a constant stride addressing mode. In a constant stride addressing mode, data can be arranged in memory such that each successive access is a constant number of bytes apart, which can be well suited for vector processing and/or array manipulations. In other embodiments, the memory addressing mode can comprise an indexed stride addressing mode. The indexed stride addressing mode can combine a base address with an index and a stride to access memory locations. This allows for flexible and efficient memory access patterns and can be useful in array and matrix manipulations. In further embodiments, the memory addressing mode can comprise a unit stride addressing mode. In a unit stride addressing mode, successive memory accesses can be adjacently located (that is, the stride between memory accesses is one). The flow 100 includes deciding to divide a vector operation 130. In disclosed techniques, the deciding can be based on opcodes that are indicative of an instruction being a scalar type of instruction or a vector type of instruction. The deciding can be based on a known complexity of the instruction that was received. The deciding can include combinational logic, content addressable memory (CAM), a lookup table, and so on.

The flow 100 includes sending, by the dispatch unit, the vector memory operation 140 to a first vector input queue within a plurality of vector input queues. The vector memory operation can include a vector load operation. The vector load operation can include loading one or more values stored in memory to one or more vector registers. The vector memory operation can include a vector store operation. The vector store operation can include storing one or more values from vector registers into memory. The first vector input queue can be coupled to the dispatch unit and used to store vector instructions. The vector instructions can include vector instructions that are to be divided into one or more micro-operations. In embodiments, the sending is based on the addressing mode 142. As described above, the addressing mode can include a constant stride addressing mode, an indexed stride addressing mode, a unit stride addressing mode, and/or another suitable addressing mode. A vector operation associated with any addressing mode can be sent to the first vector input queue. Alternatively, if the vector operation is associated with a unit stride index mode, the vector instruction can either be sent to the first vector input queue or to a scalar queue.

The flow 100 further includes splitting, by a micro-operation sequencer within the first vector input queue, the vector memory operation 150 into one or more memory micro-operations. In embodiments, the vector memory operation comprises a vector load operation. In further embodiments, the first vector input queue comprises a vector load input queue (VLIQ). In other embodiments, the vector memory operation comprises a vector store instruction. In further embodiments, the vector input queue comprises a vector store input queue (VSIQ).

Once in the first vector input queue, the vector memory operation can be split into two or more micro-operations. In one or more examples, the number of micro-operations can include a power of two. The splitting can be accomplished using a micro-operation sequencer that can be located in the input queue. Separating the micro-operation sequencer from the decode unit of the processor core can enable concurrent processing of scalar and vector memory instructions without stalling due to dispatching multiple memory micro-operations. The splitting by the micro-operation sequencer can be accompanied by a variety of techniques that can keep track of the micro-operations. Each memory micro-operation in the series of memory micro-operations can correspond to a unique vector element. In one or more examples, the micro-operation sequencer can uniquely identify a series of micro-operations associated with a vector operation, as well as identify a particular vector element as corresponding to a specific micro-operation. In examples, the micro-operation sequencer can enable tracking operational flow among pipeline stages of the execution pipeline of the processor core. Embodiments include forwarding each micro-operation 152 within the one or more micro-operations to a first memory queue within a plurality of memory queues. The memory queue can comprise a vector load queue (VLQ), and/or a vector store queue (VSQ) to store micro-operations associated with a vector load operation or a vector store operation, respectively. The memory micro-operations can be sent to the appropriate memory queue from the micro-operation sequencer within the first vector input queue. In embodiments, the first memory queue comprises a vector load queue (VLQ). In other embodiments, the first memory queue comprises a vector store queue (VSQ).

The flow 100 includes issuing, to a load-store unit within the processor core, a memory operation 160. From the memory queue, memory micro-operations can be sent to an execution unit, such as a load-store unit, for execution. In embodiments, the plurality of memory queues includes a scalar load request queue (LRQ). In some embodiments, the plurality of memory queues includes a scalar store request queue (SRQ).

One or more exemplary implementations can support concurrent execution of multiple micro-operations, yielding a higher instruction throughput. In one or more examples, the micro-operations can be executed out of order. The micro-operations can include instructions to cause the processor to load data from a cache within a cache hierarchy into an element of a vector register. Embodiments include selecting, from the plurality of memory queues 162, the memory operation. In embodiments, the selecting comprises choosing between a scalar load operation within the LRQ and a micro-operation within the one or more micro-operations within the VLQ. In other embodiments, the selecting comprises choosing between a scalar store operation within the SRQ and a micro-operation within the one or more micro-operations within the VSQ. In embodiments, the choosing is based on a reorder buffer identification (ROBID).

In some embodiments, the ROBID indicates an oldest instruction within the plurality of memory queues. The choosing can be accomplished with one or more multiplexors (muxes). The muxes can be controlled with a control signal that is based on an instruction type associated with a lowest ROBID value. When the lowest ROBID value indicates a scalar instruction, the mux can be configured to select from a memory queue utilized for scalar instructions. Similarly, when the lowest ROBID value indicates a vector instruction, the mux can be configured to select from a memory queue utilized for vector instructions. In one or more examples, the ROBID can be implemented as a sequentially incrementing counter. In one or more examples, rollover logic can be implemented to handle the case of the counter rolling over to continue proper instruction operation. The rollover logic can include detection, where the ROBID value is monitored for overflow. When the ROBID reaches a maximum value (e.g., (0xFFFFFFFF), it rolls over to zero on the next increment. The rollover logic can ensure that any logic dependent on the counter value can handle the wraparound from the maximum value back to zero. One or more examples may accomplish this by utilizing unsigned integer arithmetic.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

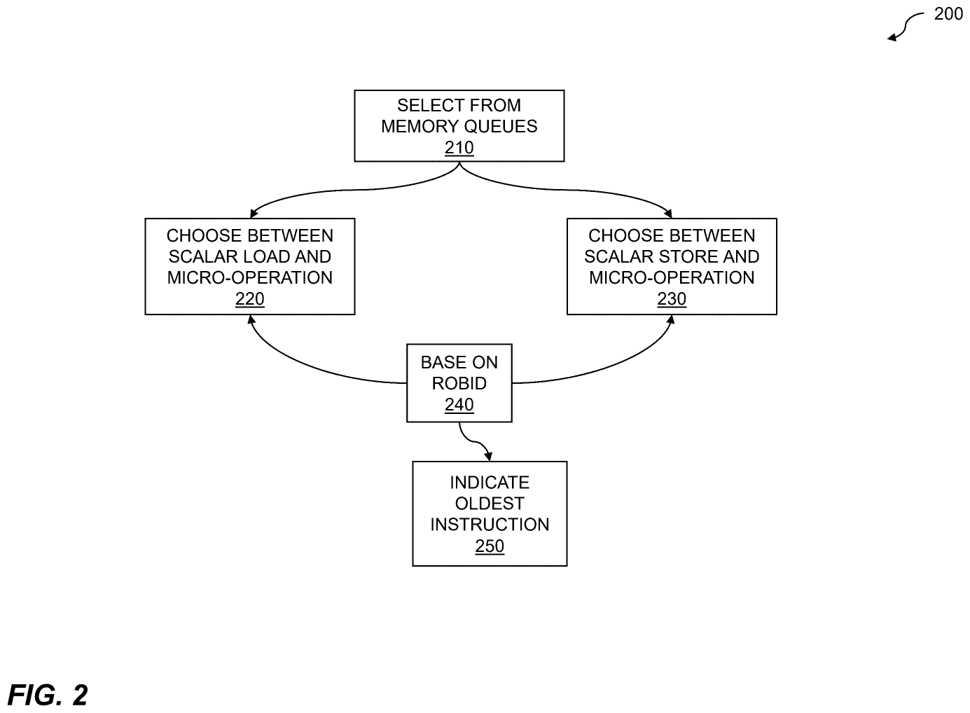

FIG. 2 is a flow diagram for selecting from memory queues. The flow 200 includes selecting, from the plurality of memory queues 210, the memory operation. As explained above, a memory operation can be dispatched to any one of a number of memory queues. These can include scalar memory queues and vector memory queues. The scalar memory queues can include a load request queue (LRQ), a scalar store request queue (SRQ), etc. The vector memory queues can include a vector load queue (VLQ), a vector store queue (VSQ), and so on. Instructions within the VLQ and/or VSQ can comprise micro-operations that were split by a micro-operation sequencer in a previous stage (the VLIQ and VSIQ, respectively). Memory instructions that have been forwarded to one of the memory queues can indicate that the instruction is ready to be sent to an execution pipeline, such as a load-store pipeline.

In embodiments, the selecting comprises choosing between a scalar load operation within the LRQ and a micro-operation within the one or more micro-operations within the VLQ 220. The selecting can determine whether a scalar memory load instruction within the LRQ or a vector load micro-operation within the VLQ is sent to the load-store unit for execution. In other embodiments, the selecting comprises choosing between a scalar store operation within the SRQ and a micro-operation within the one or more micro-operations within the VSQ 230. In this case, the selecting can determine whether a scalar memory store instruction within the SRQ or a vector store micro-operation within the VSQ is sent to the load-store unit for execution. Any instruction, once sent to the load-store unit, can be processed out of order. The out-of-order processing may be a result of compiler optimizations, resource utilization issues, dependency delays, and so on.

In embodiments, the choosing is based on a reorder buffer identification (ROBID) 240. In further embodiments, the ROBID indicates an oldest instruction 250 within the plurality of memory queues. A lower ROBID can indicate an older instruction. As explained above, the choosing can be accomplished with one or more muxes. The muxes can be controlled with a control signal that is based on an instruction type associated with a lowest ROBID value. In disclosed examples, the instruction associated with the lowest ROBID is the oldest instruction, and is the instruction that can be issued first. In embodiments, the ROBID indicates an oldest instruction within the plurality of memory queues. In one or more examples, rollover logic can be implemented to handle the case of the counter rolling over to continue proper instruction operation. The rollover logic can include detection, where the ROBID value is monitored for overflow.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

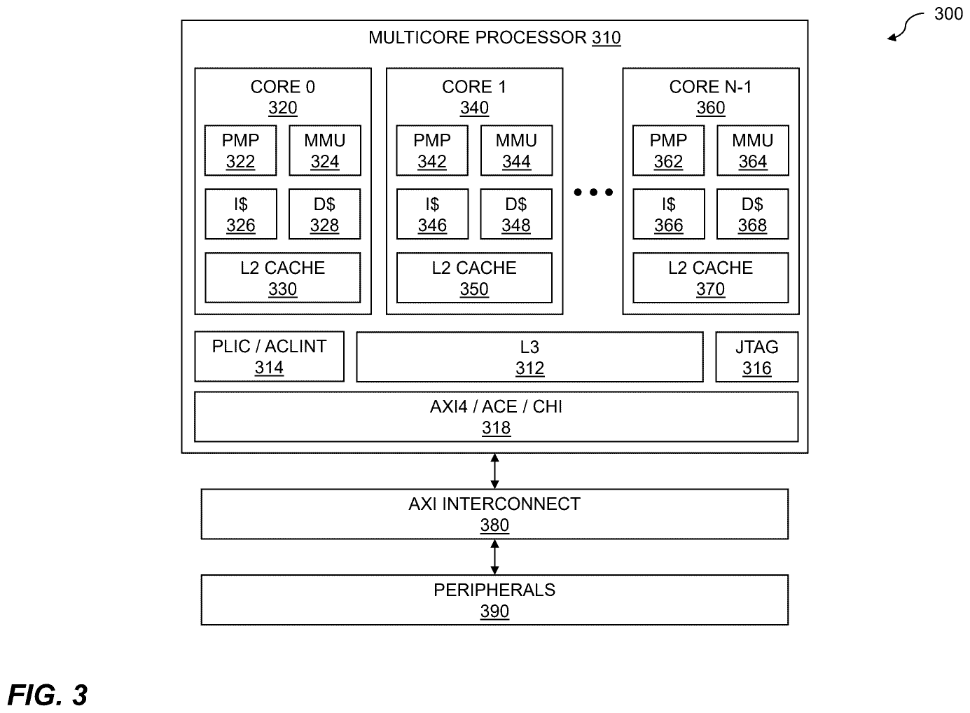

FIG. 3 is a block diagram of a multicore processor. The processor, such as a RISC-VTM processor, ARM processor, or other suitable processor type, can include a variety of elements. The elements can include processor cores including multiprocessor cores, one or more caches, memory protection and management units, local storage, and so on. In one or more exemplary implementations, the processor core enables non-blocking vector instruction dispatch with micro-operations. The elements of the multicore processor can further include one or more of a private cache; a test interface such as a joint test action group (JTAG) test interface; one or more interfaces to a network such as a network-on-chip, shared memory, and peripherals; and the like. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. The vector operation is split into a series of micro-operations by a micro-operation sequencer.

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In one or more implementations, each core, including cores 0 through core N-1, can include a physical memory protection (PMP) element, such as PMP 322 for core 0; PMP 342 for core 1, and PMP 362 for core N-1. In a processor architecture such as the RISC-VTM architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include L2 cache 330 associated with core 0; L2 cache 350 associated with core 1; and L2 cache 370 associated with core N-1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In one or more implementations, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

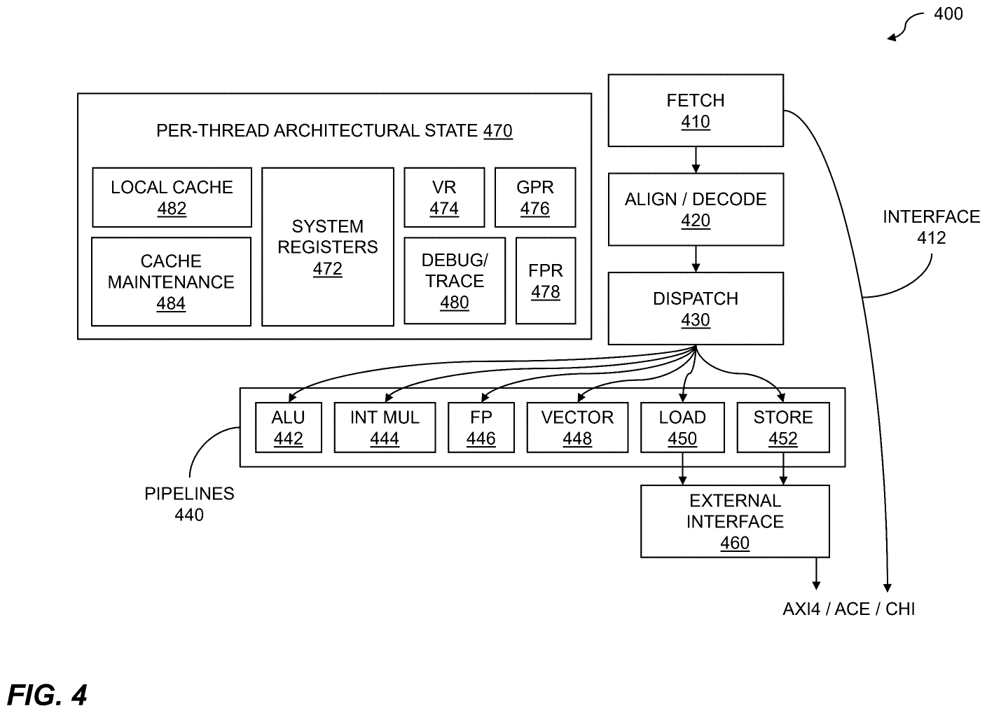

FIG. 4 is a block diagram of a pipeline. The use of one or more pipelines associated with a processor architecture can greatly enhance processing throughput. The processor architecture can be associated with one or more processor cores. The processing throughput can be increased because multiple operations can be executed in parallel. In one or more implementations, a processor core is accessed, where the processor core supports vector operations. The processor core enables non-blocking vector instruction dispatch with micro-operations. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations by a micro-operation sequencer.

The blocks within the block diagram can be configurable in order to provide varying processing levels. The varying processing levels can be based on processing speed, bit lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450 and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 470. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. In one or more exemplary implementations, the width of the vector register file is 512 bits. Additional registers such as general-purpose registers (GPR) 476 and floating-point registers (FPR) 478 can be included. These registers can be used for general purpose (e.g., integer) operations and floating-point operations, respectively. The per-thread architectural state can include a debug and trace block 480. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

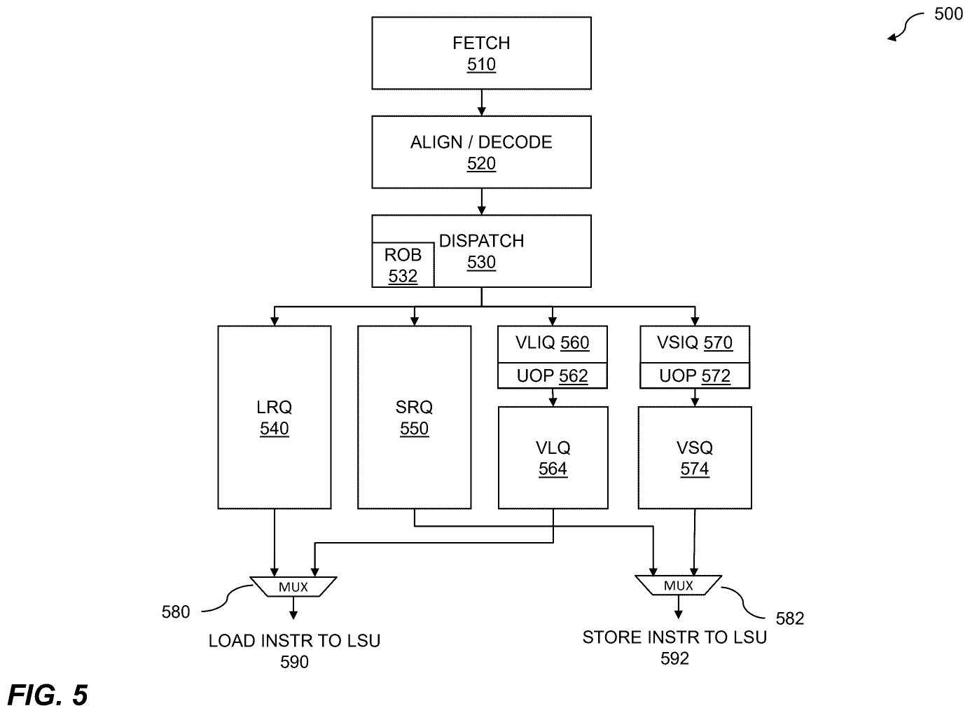

FIG. 5 is a block diagram for dispatching instructions. The block diagram 500 includes a fetch unit 510. In one or more examples, the fetch unit can perform functions such as retrieving the next instruction from memory based on a program counter (PC). The fetch unit may also perform functions that include incrementing the PC to point to the next instruction. In one or more examples, the fetch unit may also participate in branch prediction to improve instruction flow efficiency. Additionally, the fetch unit may interact with one or more instruction caches to reduce latency when fetching instructions. In one or more examples, the fetch unit may be similar to fetch block 410 shown in FIG. 4. Once instructions are fetched, the instructions are provided to the align/decode unit 520. The align/decode unit may perform functions that include aligning instruction boundaries to ensure proper processing. Additionally, the align/decode unit may perform operations of translating binary instruction codes into control signals and fields needed for execution, and also identifying and retrieving operands from registers based on the instruction. The operands can include, but are not limited to, register operands, immediate operands (to support constants embedded directly within the instruction), memory operands, PC-relative operands (addresses calculated relative to the current value of the program counter, often used for branching), indexed operands, and/or other types of operands. In one or more examples, align/decode unit may be similar to align/decode block 420 shown in FIG. 4.

Once the instructions are decoded, the instructions can be provided to the dispatch unit 530. In one or more examples, the dispatch unit can perform functions that include assigning instructions to available execution units based on readiness and resource availability. The dispatch unit can include a reorder buffer (ROB) 532. In one or more examples, the ROB can keep track of the order of instructions as they are issued and executed out of order. The ROB can enable proper instruction retirement by ensuring that instructions are completed and results are written back in the correct program order. The ROB can include multiple entries, where each entry corresponds to an instruction in the dispatch unit. A reorder buffer identification (ROBID) can refer to an entry in the ROB.

Based on the instruction type, the dispatch unit can send instructions to one of various queues for further processing. Recall that the dispatch unit can send a vector memory operation to a first vector input queue. In embodiments, the vector memory operation comprises a vector load instruction. In further embodiments, the first vector input queue comprises a vector load input queue (VLIQ) 560. Thus, the VLIQ can store one or more vector load instructions. A micro-operation sequencer 562 within the VLIQ can split the one or more vector load instructions into one or more vector load micro-operations. The above can also apply to a vector store instruction. In embodiments, the vector memory operation comprises a vector store instruction. In further embodiments, the first vector input queue comprises a vector store input queue (VSIQ) 570. Thus, the VSIQ can store one or more vector store instructions. A micro-operation sequencer 572 within the VSIQ can split the one or more vector store instructions into one or more vector store micro-operations.

In one or more examples, the micro-operation sequencer (whether within the VLIQ or the VSIQ) can be implemented as a finite state machine, which takes inputs that can include a type register, a source register, and/or a destination register. The micro-operation sequencer logic can ensure that it increments source register(s) and destination register(s) as per requirement of the processor vector specification when it breaks the instruction into individual micro-operations. The processor vector specification can include a RISC-V vector specification. In one or more examples, the splitting, the executing, and the determining are performed by a micro-operation sequencer that is separate from a dispatch unit of the processor core.

An important benefit of the vector instruction input queues (VLIQ and VSIQ) is that they alleviate the need for the dispatch unit to split complex vector instructions into micro-operations to then be dispatched to an appropriate execution unit. This splitting can result in numerous vector instructions that must be dispatched, potentially causing stalls in other instructions waiting to be dispatched, such as a scalar load, scalar store, or another vector memory operation that can also require splitting by the micro-operation sequencer. Instead, by pushing the micro-operation sequencer into the VSIQ and VLIQ, the dispatch unit can quickly process instructions and avoid stalls due to micro-operation sequences.

Recall that the processor can include a plurality of memory queues. The memory queues can send instructions directly to an execution unit, such as a load-store unit. In embodiments, the plurality of memory queues includes a scalar load request queue (LRQ) 540. The LRQ can process scalar load instructions. The dispatch unit can send scalar load instructions ready to be issued to a load-store unit via the LRQ. In embodiments, the plurality of memory queues includes a scalar store request queue (SRQ) 550. The SRQ can process scalar store instructions. The dispatch unit can send scalar store instructions ready to be issued to a load-store unit via the SRQ. Recall also that a first memory queue can receive a plurality of micro-operations that were generated by splitting a vector memory operation by a micro-sequencer. In embodiments, the first memory queue comprises a vector load queue (VLQ) 564. The VLQ can process micro-operations corresponding to vector load instructions. The dispatch unit can send vector load micro-operations ready to be issued to a load-store unit via the VLQ. In embodiments, the first memory queue comprises a vector load queue (VSQ) 574. The VSQ can process micro-operations corresponding to vector store instructions. The dispatch unit can send vector store micro-operations ready to be issued to a load-store unit via the VSQ.

With the above structure, a load instruction can be selected from the LRQ or the VLQ and sent to the load-store unit for execution. Likewise, a store instruction can be selected from the SRQ or the VSQ and sent to the load-store unit for execution. The load instructions and store instructions are routed to respective muxes. In one or more exemplary implementations, the muxes may be operated by selecting one of two input signals to pass through to the output based on a control signal. Thus, the multiplexers route one of the two inputs to the output depending on the value of the control signal, enabling flexible data routing for scalar and vector memory instructions in exemplary implementations.

The load instructions (both scalar and vector) are routed to mux 580. Similarly, the store instructions (both scalar and vector) are routed to mux 582. The muxes pass instructions to respective load store units. Mux 580 is configured to select between scalar load instructions from LRQ and vector load instructions from VLQ. Similarly, mux 582 is configured to select between scalar store instructions from SRQ and vector store instructions from VSQ. The ROBID can be used as a criterion for configuring the muxes to select the proper scalar or vector instruction to issue an oldest instruction to an execution pipeline. Mux 580 can be configured to provide the proper load instruction to load store unit 590 based on the ROBID. Similarly, mux 582 can be configured to provide the proper load instruction to load store unit 592 based on the ROBID.

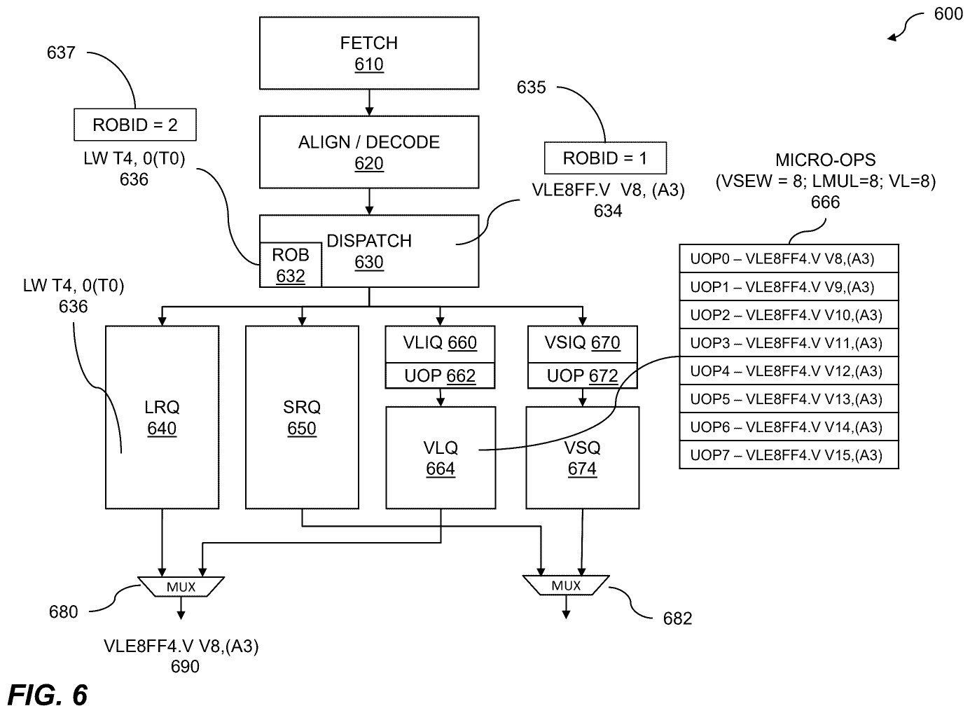

FIG. 6 is an example of dispatching vector and scalar instructions. The example 600 includes a fetch unit 610. In one or more examples, the fetch unit 610 can perform functions such as retrieving the next instruction from memory based on a program counter (PC). The fetch unit may also perform functions that include incrementing the PC to point to the next instruction. In one or more examples, the fetch unit may also participate in branch prediction to improve instruction flow efficiency. Additionally, the fetch unit may interact with one or more instruction caches to reduce latency when fetching instructions. In one or more examples, the fetch unit may be similar to fetch block 410 shown in FIG. 4. Once instructions are fetched, the instructions are provided to the align/decode unit 620. The align/decode unit may perform functions that include aligning instruction boundaries to ensure proper processing. Additionally, the align/decode unit may perform operations of translating binary instruction codes into control signals and fields needed for execution, and also identifying and retrieving operands from registers based on the instruction. In one or more examples, the align/decode unit may be similar to the align/decode block 420 shown in FIG. 4.

Once the instructions are decoded, the instructions can be provided to the dispatch unit 630. In one or more examples, the dispatch unit can perform functions that include assigning instructions to available execution units based on readiness and resource availability. The dispatch unit can include a reorder buffer (ROB) 632. In one or more examples, the ROB can keep track of the order of instructions as they are issued and executed out of order. The ROB can enable proper instruction retirement by ensuring that instructions are completed and results are written back in the correct program order. The ROB can include multiple entries, where each entry corresponds to an instruction in the dispatch unit. A reorder buffer identification (ROBID) can refer to an entry in the ROB.

In the example of FIG. 6, a vector load instruction 634 and a scalar load instruction 636 enter the dispatch unit 630. In this particular example, the vector load instruction is a vector load 8-byte instruction that loads data into vector register V8 from the address that is referenced in general-purpose register A3. The scalar load instruction is a load word instruction that loads a 32-bit word from memory using a source address that is calculated as the sum of the base address in register T0 with an offset of 0, and the loaded word is stored in the destination register T4. The vector load instruction has a corresponding ROBID 635 that has a value of 1. Similarly, the scalar load instruction has a corresponding ROBID 637 that has a value of 2. The dispatch unit routes the vector load instruction to the vector load input queue (VLIQ) 660. The routing occurs prior to dividing the vector load instruction into multiple micro-operations. By routing the vector load instruction to the vector load input queue (VLIQ) prior to dividing the vector load instruction into multiple micro-operations, the dispatch unit can begin processing the following scalar load instruction. Thus, the processing of the scalar load instruction is not impeded while the vector load instruction is being split into multiple micro-operations. The micro-operation sequencer 662 creates micro-operations 666 corresponding to the vector load instruction. The micro-operations are input to vector load queue 664 for processing. Concurrent with the processing of the vector load instruction by the micro-operations sequencer, the scalar load instruction can be provided to load request queue 640 for further processing, thereby improving overall processer performance. Mux 680 can select between the load request queue and vector load queue for which instruction is the next instruction to be issued. In the example of FIG. 6, the vector load instruction has a ROBID value of 1, which is less than the scalar instruction's ROBID value of 2. Therefore, the vector load instruction is output from the mux 680 first, indicated at 690. In one or more exemplary implementations, the dispatch unit controls the output mux 680 to select the instruction with the lowest ROBID. Once the instruction exits the scalar load request queue or the vector load queue, the dispatch unit can clear the ROBID corresponding to that instruction. As illustrated in the example of FIG. 6, since the vector instruction has the lower ROBID value, the mux 680 is initially configured to select from the vector load queue. Once the instruction leaves the vector load queue, the corresponding entry in the ROB is cleared. In one or more exemplary implementations, the clearing can include entering a special value in the corresponding ROBID slot, such as 0xFFFF (for a 16-bit ROB), to indicate an empty slot. Once the ROBID slot corresponding to instruction 634 is indicated as empty, the new lowest value ROBID is indicated at 637. Accordingly, the dispatch unit can then reconfigure the mux 680 to select load request queue 640, to allow scalar load instruction 636 to be passed through mux 680 towards subsequent stages of the instruction pipeline.

While the aforementioned example describes selection between a scalar load instruction and a vector load instruction, a similar operation can occur for selection between a scalar store instruction and a vector store instruction. In the case of a vector store instruction, the dispatch unit can route the vector store instruction to vector store input queue 670, where it is then input to micro-operation sequencer 672. Micro-operations from the micro-sequencer can subsequently be passed to vector store queue 674. Similar to the case above for load instructions, mux 682 can be controlled by the dispatch unit to select the proper instruction for retirement based on a ROBID, either from SRQ 650 or from VSQ 674. In one or more exemplary implementations, the dispatch unit determines the instruction associated with the lowest ROBID, determines the instruction type as vector or scalar, based on opcodes, and configures the mux (680 or 682) accordingly. Vector store instructions are routed by the dispatch unit to the vector store input queue for further processing, while scalar store instructions are routed by the dispatch unit to the store request queue for further processing. Accordingly, exemplary implementations can maximize resource utilization by allowing independent instructions to proceed without waiting, while preserving data integrity by ensuring that data dependencies are respected, preventing hazards such as read-after-write (RAW) from corrupting computational results.

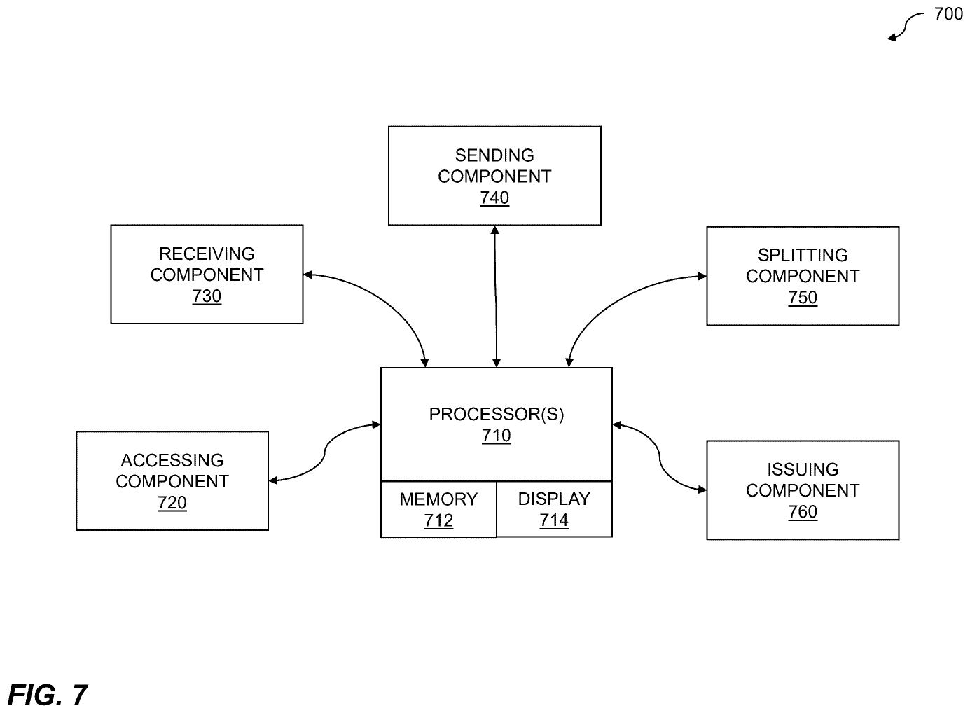

FIG. 7 is a system diagram for non-blocking vector instruction dispatch with micro-operations. The system 700 can include instructions and/or functions for design and implementation of integrated circuits that support vector operation sequencing for non-blocking vector instruction dispatch with micro-operations. The system 700 can include instructions and/or functions for generation and/or manipulation of design data such as hardware description language (HDL) constructs for specifying structure and operation of an integrated circuit. The system 700 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 700 can include one or more processors 710. The processors can include standalone processors within integrated circuits or chips, processor cores in FPGAs or ASICs, and so on. The one or more processors 710 are coupled to a memory 712, which stores operations. The memory can include one or more of local memory, cache memory, system memory, etc. The system 700 can further include a display 714 coupled to the one or more processors 710. The display 714 can be used for displaying data, instructions, operations, and the like. The operations can include instructions and functions for implementation of integrated circuits, including processor cores. In exemplary implementations, the processor cores can include RISC-V™ processor cores. A system comprising the one or more processors 710, when executing the instructions which are stored in the memory 712, is configured to enable non-blocking vector instruction dispatch with micro-operations.

The system 700 can include an accessing component 720. The accessing component 720 can include functions and instructions for accessing a processor core, wherein the processor core is coupled to a memory hierarchy, and wherein the processor core is configured to execute vector instructions, scalar instructions, and micro-operations. The processor core can include an ARM core, a MIPS core, and/or other suitable core type. In one or more exemplary implementations, the processor core can include a RISC-V architecture. The processor core can support vector operations. The RISC-V architecture can include extensions, where the extensions can enable execution of various arithmetic and logic operations. In exemplary implementations, RISC-V architecture can include vector extensions. In exemplary implementations, the vector extensions can include ELEN, VLEN, SEW, LMUL, VLMAX, VL, and VSTART components. The processor core includes an execution pipeline, where the execution pipeline is configured to execute micro-operations. The micro-operations can include accessing a vector register, a starting address for data, a source register, a destination register, and so on.

The system 700 can include a receiving component 730. The receiving component 730 can include functions and instructions for receiving, by a dispatch unit within the processor core, a vector memory operation, wherein the vector memory operation is associated with a memory addressing mode, wherein the receiving includes deciding to divide the vector memory operation into one or more micro-operations. In one or more exemplary implementations, the receiving can include receiving scalar memory instructions and/or vector memory instructions. The memory instructions can include memory load instructions and/or memory store instructions.

The system 700 can include a sending component 740. The sending component 740 can include functions and instructions for sending, by the dispatch unit, the vector memory operation to a first vector input queue within a plurality of vector input queues, wherein the sending is based on the memory addressing mode. In one or more exemplary implementations, the sending can include sending a vector memory instruction to a vector input queue. In one or more exemplary implementations, the vector input queue can include a vector load input queue and/or a vector store input queue.

The system 700 can include a splitting component 750. The splitting component 750 can include functions and instructions for splitting, by a micro-operation sequencer within the first vector input queue, the vector memory operation into one or more memory micro-operations, wherein the splitting includes forwarding each micro-operation within the one or more micro-operations to a first memory queue within a plurality of memory queues. The series of micro-operations can be generated by a micro-operation sequencer that is coupled to a vector memory input queue, such as a vector load input queue and/or a vector store input queue. The micro-instructions generated by the micro-operation sequencer can depend on the type of vector operation.

The system 700 can include an issuing component 760. The issuing component 760 can include functions and instructions for issuing, to a load-store unit within the processor core, a memory operation, wherein the issuing includes selecting, from the plurality of memory queues, the memory operation. The memory operation can include a scalar memory operation and/or a vector memory operation. The scalar operations can include, but are not limited to, operations such as load word and store word, load byte and store byte, load byte unsigned and store byte unsigned, and/or other load instructions that support loading data from memory into a register, and/or storing data from a register into memory. Similarly, vector memory operations can include loading vector element values from memory into registers, and/or storing vector element values from registers into memory.

The system 700 can include a computer program product embodied in a non-transitory computer readable medium for instruction execution, the computer program product comprising code which causes one or more processors to generate semiconductor logic for: accessing a processor core, wherein the processor core is coupled to a memory hierarchy, and wherein the processor core is configured to execute vector instructions, scalar instructions, and micro-operations; receiving, by a dispatch unit within the processor core, a vector memory operation, wherein the vector memory operation is associated with a memory addressing mode, wherein the receiving includes deciding to divide the vector memory operation into one or more micro-operations; sending, by the dispatch unit, the vector memory operation to a first vector input queue within a plurality of vector input queues, wherein the sending is based on the memory addressing mode; splitting, by a micro-operation sequencer within the first vector input queue, the vector memory operation into one or more memory micro-operations, wherein the splitting includes forwarding each micro-operation within the one or more micro-operations to a first memory queue within a plurality of memory queues; and issuing, to a load-store unit within the processor core, a memory operation, wherein the issuing includes selecting, from the plurality of memory queues, the memory operation.

The system 700 can include a computer system for instruction execution comprising: a memory which stores instructions; one or more processors coupled to the memory wherein the one or more processors, when executing the instructions which are stored, are configured to: access a processor core, wherein the processor core is coupled to a memory hierarchy, and wherein the processor core is configured to execute vector instructions, scalar instructions, and micro-operations; receive, by a dispatch unit within the processor core, a vector memory operation, wherein the vector memory operation is associated with a memory addressing mode, wherein the receiving includes deciding to divide the vector memory operation into one or more micro-operations; send, by the dispatch unit, the vector memory operation to a first vector input queue within a plurality of vector input queues, wherein the sending is based on the memory addressing mode; split, by a micro-operation sequencer within the first vector input queue, the vector memory operation into one or more memory micro-operations, wherein the splitting includes forwarding each micro-operation within the one or more micro-operations to a first memory queue within a plurality of memory queues; and issue, to a load-store unit within the processor core, a memory operation, wherein the issuing includes selecting, from the plurality of memory queues, the memory operation.

As can now be appreciated, exemplary implementations can improve processor performance by enabling out-of-order execution and the improved resource utilization that out-of-order execution provides, while mitigating the bottlenecks and performance hits that could occur when vector operations are intermixed with scalar operations in an instruction pipeline. One or more exemplary implementations send vector memory instructions to an input queue, where the vector memory instructions are divided into multiple micro-operations while the dispatch unit is then available to process subsequent scalar instructions. In this way, exemplary implementations can enable independent scheduling and execution, enhancing performance for diverse workloads, resulting in more efficient processing and better utilization of processor capabilities.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for vector processing comprising:
accessing a processor core, wherein the processor core is coupled to a memory hierarchy, and wherein the processor core is configured to execute vector instructions, scalar instructions, and micro-operations;
receiving, by a dispatch unit within the processor core, a vector memory operation, wherein the vector memory operation is associated with a memory addressing mode, wherein the receiving includes deciding to divide the vector memory operation into one or more micro-operations;
sending, by the dispatch unit, the vector memory operation to a first vector input queue within a plurality of vector input queues, wherein the sending is based on the memory addressing mode;
splitting, by a micro-operation sequencer within the first vector input queue, the vector memory operation into one or more memory micro-operations, wherein the splitting includes forwarding each micro-operation within the one or more micro-operations to a first memory queue within a plurality of memory queues; and
issuing, to a load-store unit within the processor core, a memory operation, wherein the issuing includes selecting, from the plurality of memory queues, the memory operation.

2. The method of claim 1 wherein the vector memory operation comprises a vector load operation.

3. The method of claim 2 wherein the first vector input queue comprises a vector load input queue (VLIQ).

4. The method of claim 3 wherein the first memory queue comprises a vector load queue (VLQ).

5. The method of claim 4 wherein the plurality of memory queues includes a scalar load request queue (LRQ).

6. The method of claim 5 wherein the selecting comprises choosing between a scalar load operation within the LRQ and a micro-operation within the one or more micro-operations within the VLQ.

7. The method of claim 6 wherein the choosing is based on a reorder buffer identification (ROBID).

8. The method of claim 7 wherein the ROBID indicates an oldest instruction within the plurality of memory queues.

9. The method of claim 1 wherein the vector memory operation comprises a vector store instruction.

10. The method of claim 9 wherein the vector input queue comprises a vector store input queue (VSIQ).

11. The method of claim 10 wherein the first memory queue comprises a vector store queue (VSQ).

12. The method of claim 11 wherein the plurality of memory queues includes a scalar store request queue (SRQ).

13. The method of claim 12 wherein the selecting comprises choosing between a scalar store operation within the SRQ and a micro-operation within the one or more micro-operations within the VSQ.

14. The method of claim 13 wherein the choosing is based on a reorder buffer identification (ROBID).

15. The method of claim 14 wherein the ROBID indicates an oldest instruction within the plurality of memory queues.

16. The method of claim 1 wherein the memory addressing mode comprises a constant stride addressing mode.

17. The method of claim 1 wherein the memory addressing mode comprises an indexed stride addressing mode.

18. The method of claim 1 wherein the memory hierarchy comprises an L1 cache, an L2 cache, and an L3 cache.

19. A computer program product embodied in a non-transitory computer readable medium for instruction execution, the computer program product comprising code which causes one or more processors to generate semiconductor logic for:
accessing a processor core, wherein the processor core is coupled to a memory hierarchy, and wherein the processor core is configured to execute vector instructions, scalar instructions, and micro-operations;
receiving, by a dispatch unit within the processor core, a vector memory operation, wherein the vector memory operation is associated with a memory addressing mode, wherein the receiving includes deciding to divide the vector memory operation into one or more micro-operations;
sending, by the dispatch unit, the vector memory operation to a first vector input queue within a plurality of vector input queues, wherein the sending is based on the memory addressing mode;
splitting, by a micro-operation sequencer within the first vector input queue, the vector memory operation into one or more memory micro-operations, wherein the splitting includes forwarding each micro-operation within the one or more micro-operations to a first memory queue within a plurality of memory queues; and
issuing, to a load-store unit within the processor core, a memory operation, wherein the issuing includes selecting, from the plurality of memory queues, the memory operation.

20. A computer system for instruction execution comprising:
a memory which stores instructions;
one or more processors coupled to the memory, wherein the one or more processors, when executing the instructions which are stored, are configured to:
access a processor core, wherein the processor core is coupled to a memory hierarchy, and wherein the processor core is configured to execute vector instructions, scalar instructions, and micro-operations;
receive, by a dispatch unit within the processor core, a vector memory operation, wherein the vector memory operation is associated with a memory addressing mode, wherein the receiving includes deciding to divide the vector memory operation into one or more micro-operations;
send, by the dispatch unit, the vector memory operation to a first vector input queue within a plurality of vector input queues, wherein the sending is based on the memory addressing mode;
split, by a micro-operation sequencer within the first vector input queue, the vector memory operation into one or more memory micro-operations, wherein the splitting includes forwarding each micro-operation within the one or more micro-operations to a first memory queue within a plurality of memory queues; and
issue, to a load-store unit within the processor core, a memory operation, wherein the issuing includes selecting, from the plurality of memory queues, the memory operation.
